(19) United States
(12) Patent Application Publication
(10) Pub. No.: US 2019/0295027 A1
(43) Pub. Date: Sep. 26, 2019

(54) COGNITIVE SCHEDULING FOR COOPERATIVE TASKS

(71) Applicant: International Business Machines Corporation, Armonk, NY (US)

(72) Inventors: Jonathan DUNNE, Mulhuddart (IE); Liam S. HARPUR, Mulhuddart (IE); Kelley ANDERS, Annapolis Junction, MD (US); Jeremy R. FOX, Austin, TX (US)

(21) Appl. No.: 15/935,338

(22) Filed: Mar. 26, 2018

(51) Int. Cl. G06Q 10/06; G06Q 10/10

(52) U.S. Cl. CPC G06Q 10/063118; G06Q 10/067; G06Q 10/063112; G06Q 10/1097

(57) ABSTRACT

Methods, computer program products, and systems are presented. The methods include, for instance: obtaining the group task to be performed by two or more individual members is specified by a task profile including a type of required skill to perform the group task. Member availabilities are respectively modeled based on estimated time of completion and calendar of each member. A group free time model is built based on individual availability models, and a subgroup of the individual members is selected and the group task is assigned by notification.

### TECHNICAL FIELD

The present disclosure relates to cognitive real time processing and machine learning technology, and more particularly to methods, computer program products, and systems for coordinating a schedule for tasks which require collaboration amongst multiple participants.

### BACKGROUND

When people form a certain organization, there are collaborative tasks that are to be performed by two or more members at the same time. Such collaborative tasks, however, are time consuming to assign due to the decisions on who are going to be on a team to perform the collaborative tasks, and on which time slot works for all members selected for the team. As the members have respective personal schedules for social activities other than the matters of the organization, it is rare that all of the members of the team to be available for the collaborative tasks at the same time. Further, such personal schedules and corresponding availabilities are subject to change, even after scheduling a collaborative task for a team including many people in their respective free time, the collaborative task may not take place and/or be completed as scheduled.

### SUMMARY

The shortcomings of the prior art are overcome, and additional advantages are provided, through the provision, in one aspect, of a method. The method for cognitively scheduling a group task for a plurality of individual members includes, for instance: obtaining, by one or more processor, the group task, where the group task is to be performed by two or more individual members, where the group task is specified by a task profile including a type of required skill to perform the group task; modeling, by the one or more processor, respective availabilities of the individual members for the group task, based on respectively estimated time of completion, and based on respective member calendar; building, by the one or more processor, a group free time model, by use of availability models for the individual members from the modeling; selecting, by the one or more processor, a subgroup of the individual members to assign the group task, based on the group free time model, member preference, and a team score, if applicable; and notifying, by the one or more process, all members of the subgroup that the group task has been assigned to the subgroup such that the members selected for the subgroup would gather and/or coordinate performance of the group task.

Additional features are realized through the techniques set forth herein. Other embodiments and aspects, including but not limited to computer program products and systems, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for optimized scheduling for cooperative tasks based on availability modeling, in accordance with one or more embodiments set forth herein;

FIG. 2 depicts a flowchart of operations performed by the scheduling engine, in accordance with one or more embodiments set forth herein;

FIG. 3 depicts an exemplary composition of the member list, in accordance with one or more embodiments set forth herein;

FIG. 4 depicts a cloud computing node according to an embodiment of the present invention;

FIG. 5 depicts a cloud computing environment according to an embodiment of the present invention; and

FIG. 6 depicts abstraction model layers according to an embodiment of the present invention.

### DETAILED DESCRIPTION

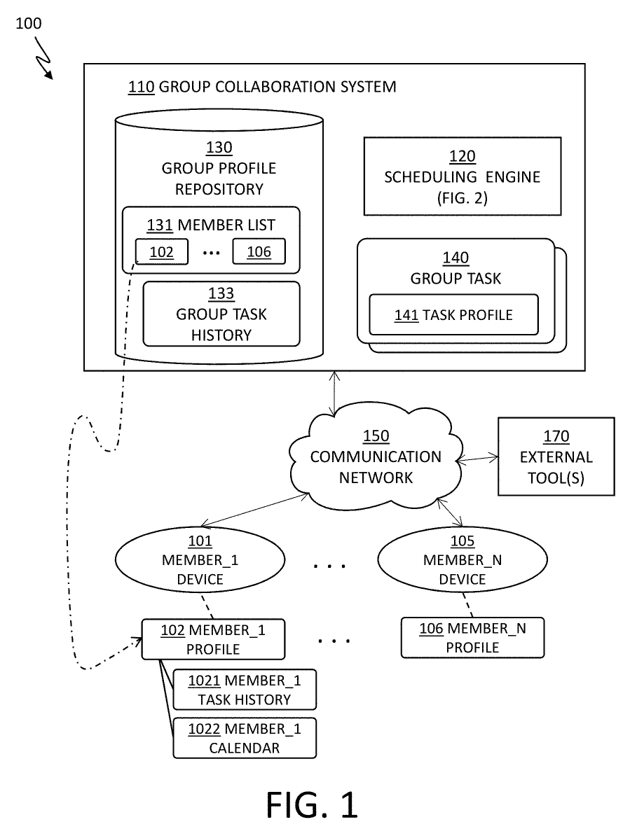

FIG. 1 depicts a system 100 for optimized scheduling for cooperative tasks based on availability modeling, in accordance with one or more embodiments set forth herein.

When people engage in voluntary social activities outside the context of regular business hours common to most people, arranging time schedule for a meeting, and/or any kind of group activities poses a challenge, as each participant has respective schedules for various familial and/or social activities, both on-line and off-line. Going back and forth amongst many people in order to find a time slot available for all members for a certain group activity is often a time consuming process, due to cumulated social schedules of respective members. Further, a collaborative activity for which availabilities of multiple members are examined may have other conditions and/or preferences for the members to participate in the specific activity, based on the nature of the activity and what each member can contribute to the activity. In this specification, terms “availability” and “social availability” are used interchangeably.

The system 100 includes a group collaboration system 110, communicating with a plurality of member device 101, 105, respective to individual members of a group, via a communication network 150. Examples of the member device 101, 105, may include, but are not limited to, a smartphone. The group collaboration system 110 is optionally coupled to one or more external tool 170, such as a social network feed, a statistical analysis and modeling tool, a task performance monitoring tool, a member feedback tool, machine learning and cognitive processing tool, and combinations thereof.

The group collaboration system 110 includes a scheduling engine 120, a group profile repository 130, and one or more group task including a group task 140.

The group task 140 is a job to be performed by more than one member. The group task 140 may be input to the group collaboration system 110 by an authorized member, a system administrator, and/or may be generated automatically for recurring tasks. The group task 140 includes a task profile 141 that specifies requirements of the group task 140, including, but not limited to, a type of required skill to perform the group task 140, a required skill level of the type of the group task 140, a number of members and/or hours estimated for the group task 140, an expected completion date, and combinations thereof.

As noted above, in this specification, the term “group task” indicates a task that requires two or more individual members to perform, and accordingly, may only be assigned to the required number of members who are simultaneously available. The term “group task” may be interchangeably used with “collaborative task”, “team task”, “cooperative task”, or the like. The term “group”, where used independently, indicates, collectively all of the individual members, and/or an organization to which all of the individual members belong. In this specification, the term “team” indicates a sub-group of the members who are assigned for a specific task.

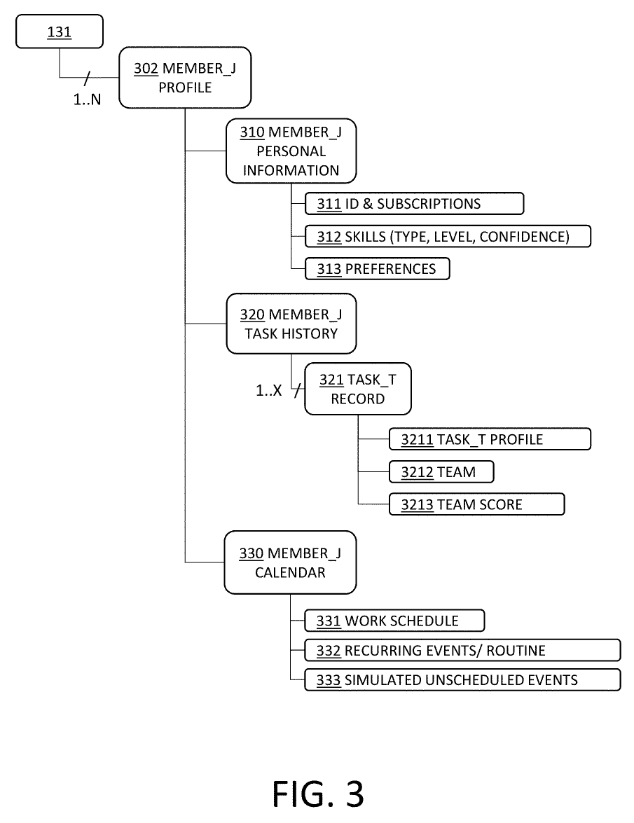

The group profile repository 130 includes a member list 131 and a group task history 133. The member list 131 is a list of all individual members participating in the group, who are eligible for assignment of the group task 140. The member list 131 includes respective member profiles 102, 106, representing each member device corresponding to the respective individual members. For example, a first member corresponding to a Member_1 device 101 is represented by a Member_1 profile 102 of the Member_1 device 101, in the member list 131. In this specification, each individual member, by way of the respective member devices, is represented by a corresponding member profile that is uniquely identified for a specific individual member. In this specification, where a member profile, a member task history, and a member calendar are directed to the same individual member, respective components are marked with an identical member number, noted as an alphanumeric postfix following an underscore (‘_’), as shown in the Member_1 profile 102, Member_1 task history 1021, and Member_1 calendar 1022. Examples of elements from the member profiles 102, 106, including the member task history and the member calendar, are provided in FIG. 3 and corresponding description.

The group task history 133 is a record of group tasks performed in the past, as described in various aspects of assignment including, but not limited to, task characteristic specified from task profiles, assigned team description, performance result and feedback on the experience of the collaboration by participating members of the team, etc. The group task history 133 may be further propagate to the member task histories for respective members. Examples of elements from a record in the group task history 133 are presented in FIG. 3 and corresponding description.

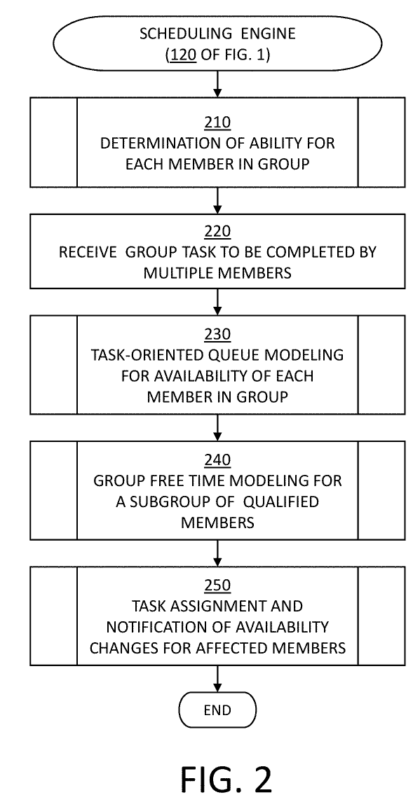

The scheduling engine 120 optimally schedules the group task 140 by coordinating various aspects of assigning the group task 140 including, but not limited to, a type of the group task 140, respective skill levels required for the group task 140 based on each type, respective availabilities of qualified members, group dynamics for best performance, etc. In order to schedule the group task 140 to the members who are determined to be the best team to perform the group task 140 together, the scheduling engine 120 builds respective ability/availability models for qualified members by utilizing information stored in the member profiles 102, 106 for each member, and/or the group task history 133 as referenced from the member profiles 102, 106, according to the requirements set forth in the task profile 141. Detailed operations of the scheduling engine 120 are presented in FIG. 2 and corresponding description.

FIG. 2 depicts a flowchart of operations performed by the scheduling engine 120 of FIG. 1, in accordance with one or more embodiments set forth herein.

The scheduling engine 120 performs blocks 210 through 250 as presented below. Where any data elements are updated during the process of the respective blocks, the scheduling engine 120 updates the respective data elements in respective data structure and/or storage components, which are not individually specified in the block descriptions. Accordingly, the scheduling engine 120 adjusts modeled data result in real-time, by use of actual data results respectively corresponding to the modeled data elements.

In block 210, the scheduling engine 120 determines respective abilities of the members in the group, by utilizing information from the member list 131 and the group task history 133, and compiling various abilities of the members. In this specification, the term “ability” indicates a combination of type of skill and a corresponding skill level, which describes the types of tasks that a member may perform, in respective effectiveness. Accordingly, in this specification, terms “ability”, “service performance”, “service efficiency”, and/or “service speed” may be used interchangeably. The scheduling engine 120 stores the determined abilities in respective member profiles 102, 106. Then the scheduling engine 120 proceeds with block 220.

In one embodiment of the present invention, abilities of a member are represented in terms of a type of skill and a corresponding skill level from a predefined scale of ranges, from basic personal information in the member profiles. For example, the type of skill may be determined based on a type of a job and the skill level on years on the job, where the group is a business institution. Accordingly, a software programmer who has been working in this position at a tech company for five (5) years, for example, may be described with a programming skill type, with a medium skill level in a scale of low-medium-high, or level two (2) in another scale of one to four (1-4). Any skill type may be further classified with specialties that are sub-classes of the skill type, as the programming skill type may be further classified according to platforms, programming languages, application functionalities, etc.

In certain embodiments of the present invention, the scheduling engine 120 further associates the simulated time of completion, also referred to as ability, with a confidence score for the ability, based on past tasks as recorded in a member task history and a member calendar for respective members. The confidence score for the ability indicates how soon, or within a required time frame, an individual member may complete the portion of the group task 120. In certain embodiments of the present invention, the scheduling engine 120 associate a skill type and a skill level with a skill confidence score, indicating a probability on how the skill type and the skill level have been accurately assessed.

In block 220, the scheduling engine 120 receives the group task 140, which requires two (2) or more members to complete, as the group task 140 has been generated by inputs from authorized users, including members and system administrators, and/or another computerized system that sends a request to perform the group task 140, periodically for recurring tasks, and/or automatically as being triggered by a preconfigured sequence of events. Then the scheduling engine 120 proceeds with block 230.

In block 230, the scheduling engine 120 performs queue modeling for respective time of completion of the group task 140 for each member, based on the type of the group task 140 as well as on the set of skills and corresponding skill levels as ascertained in block 210. As noted, the type of the group task is specified in the task profile 141. As a result, the scheduling engine 120 calculates respective estimated time of completion for each member. As noted in description of block 210, a duration of time to complete a certain task varies based on not only the type of the task, but also the abilities, as represented in the type of skill and corresponding skill level. The scheduling engine 120 subsequently simulates, for each member, when the individual member would be available to perform the group task 140, for a period of the estimated time of completion. Then the scheduling engine 120 proceeds with block 240.

In one embodiment of the present invention, the scheduling engine 140 utilizes a queue model that simulates a completion time of a task for a member, where the group task 140 includes the task of a type that may be performed individually. The scheduling engine 120 analyzes various patterns of activities and routines in respective member calendar in order to model timeframe during which a certain member would be available. The scheduling engine 120 monitors respective member calendars, before and after the modeling, such any discrepancies in modeled availability and actual free time may be reported to all members affected by such discrepancies in the availabilities.

In certain embodiments of the present invention, the scheduling engine 120 performs queue modeling for availability/ability for only the members who are qualified to participate in a team for the group task 140, by checking the member skill against the demand of the group task 140. For example, where the group task 140 demands three (3) people with Level 2 of programming skill, in a scale of Level 1-4, Level 1 being the lowest, the scheduling engine 120 filters the members having Level 1 or no programming skill out, then performs queue modeling for respective availabilities on only the filtered-in members from Level 2-4 of programming skill.

The abilities of respective members may result in differentiated durations of time until the completion of the group task 140, based on the type of skill required by the group task 140. For example, for a certain type of skill, a more skilled member, as represented by a higher skill level, may perform a task in a shorter period of time than a less skilled member, as represented by a lower skill level. Accordingly, the scheduling engine 120 may schedule the more skilled member for the group task 140 having an availability only for the shorter time for completion corresponding to the higher skill level, while the less skilled member should be available for a longer period of time corresponding to the longer time for completion. For another type of skill, the skill level may not affect the time of completion of the group task 140, as the group task 140 would be more dependent on collaboration amongst team members rather than on individual skill levels.

In certain embodiments of the present invention, the scheduling engine 120 performs queue modeling by use of renewal-reward process. In certain embodiments of the present invention, the scheduling engine 120 may utilize data resulting from discriminant function model analysis. In the same embodiments of the present invention, the scheduling engine 120 may produce updated training data for classification on various data elements of the group collaboration system 110, by incorporating the discriminant function model analysis data with user feedback.

In block 240, the scheduling engine 120 performs modeling for group free time, also referred to as group availability, and/or, cumulated availability, for one or more subgroup of the qualified members whose availability/ability has been modeled in block 230. The groups free time illustrates, based on a combination of respective calendars of all members, a time available for the all members to engage and to complete a set of tasks relative to a baseline of existing engagements. As a result, the scheduling engine 120 ascertains, to which subgroup amongst the qualified members the group task 140 is to be assigned. In selecting the members for the subgroup, the scheduling engine 120 may prioritize selecting members with the highest confidence scores associated with the skill type and the skill level of each member. Then the scheduling engine 120 proceeds with block 250.

In an embodiment of the present invention, the group free time modeling by the scheduling engine 120 may result in more than one qualified subgroup to assign the group task 140. The scheduling engine 120 may apply a preconfigured tie-breaker to select one subgroup amongst the more than one qualified subgroup. Examples of the preconfigure tie-breaker may be a better group dynamics as presented in a team score for a team, to which one or more group task had been assigned in the past. Such group dynamics information is recorded in the group task history 133, and the scheduling engine 120 analyzes the group task history 133 and determines the team score, which represents how well the members in the team work together. The preconfigured tie-breaker may be based on preferences for other team members from member personal information in the member profiles for respective members in the qualified subgroups. One exemplary data structure for the team score and the preferences is presented in FIG. 3 and corresponding description.

In block 250, the scheduling engine 250 assigns the group task 140 to the subgroup ascertained in block 240 and notifies the members of the subgroup about the assignment of the group task 140, the purported schedule to perform the group task 140, and respective availabilities of the members of the subgroup, such that the subgroup may complete the assigned group task 140 as scheduled. As the subgroup has been selected based on availabilities of the respective members, the scheduling engine 120 ensures that the members would not have any conflicts with other appointments or other calendar events, nor with any other group tasks that may have been assigned to the member, in cases that the member had not been assigned the group task 140. The scheduling engine 120 keeps tracking of respective member calendars for the members of the subgroup, and notifies, in real-time, any changes in member availabilities of the subgroup to other members such that the simulated schedule for the group task 140 may be adjusted and/or another individual member may join the subgroup. Then the scheduling engine 120 terminates processing for the group task 140.

In certain embodiments of the present invention, the scheduling engine 120 performs block 210 as one unit and blocks 220 through 250 as another unit. Block 210 may be periodically iterated to keep the member profiles for all members up to date, or upon being triggered with any updates on the member profiles. Blocks 220 through 250 may be iterated indefinitely, for each arrival of a new group task.

FIG. 3 depicts an exemplary composition of the member list 131 of FIG. 1, in accordance with one or more embodiments set forth herein.

As noted, the member list 131 of FIG. 1 includes the member profiles 102, 106 corresponding to respective members to whom the scheduling engine 120 may assign the group task 140. In the member list 131, there are N member profiles corresponding respectively to from Member_1 through to Member N.

J^{th} member Member_J, where J is a positive integer in a range of [1 . . . N], indicates any individual member in the member list 131. For Member_J, the group collaboration system 110 keeps a member profile Member_J profile 302. An exemplary instance of Member_J profile 302 stores various data component on Member_J, including Member_J personal information 310, Member_J task history 320, and Member_J calendar 330.

Member_J personal information 310 include identification (ID) and subscriptions component 311, which specifies basic personal information such as name, address, and other account/contact information. Subscriptions in the personal information may list one or more social networks and/or various online memberships, from which availability of the member may be learnt according to events and activities of a subscribed organization. For example, if Member_J subscribes to Organization A, and if Member_J avidly attends all off-line events of Organization A, then the group collaboration system 110 and the scheduling engine 120 may estimate availability of Member_J based on monitoring event calendar of Organization A.

Member_J personal information 310 includes skills 312 of Member_J, as specified by one or more 3-tuple (Type, Level, Confidence), respective to each skill configured for the group collaboration system 110. A first element Type of Member_J personal information 312 indicates a kind, or a class, of the skill of Member_J. A second element Level of Member_J personal information 312 indicates a proficiency level for Type skill of Member_J. A third element Confidence of Member_J personal information 312 indicates a probability on certainty of the skill type and the skill level represented by the first element and the second element, respectively. The third element Confidence on Type and Level may be assessed based on member input upon registration or as a feedback after performing other group tasks in the past, content of the group task history 138 and associated task profile 141 of the group task 141 that Member_J had performed in the past.

Member_J personal information 310 includes preferences 313 of Member_J, as specified by various preferences of Member_J as to a type of a task to participate in, teammates, a range for total time commitment for the group, and/or preferred time frame for group tasks, as specified by Member_J. The scheduling engine 120 may use the preferences 313 of Member_J as one of tie-breakers in selecting teammates in subgroups and assigning group tasks for which Member_J is qualified.

Member_J task history 320 may be compiled from the group task history 133 and the task profile 141 of group tasks 140 that had been performed in the past, for information relevant to Member_J.

The exemplary instance of Member_J profile 302 includes Member_J task history 320, which enumerates X number of tasks that has been performed in the past, corresponding respectively to Task_1 through Task_X. T^{th} task Task_T is represented by Task_T record 321, where T is a positive integer in a range of [1 . . . X]. Task_T record 321 indicates any task recorded in Member_J task history 320. In one instance of the member profiles, Task_T record 321 is specified with data components of Task_T profile 3211, a team 3212, and a team score 3213. Task_T profile 3211 of the Task_T record 321 is a description of Task_T, as provided in the task profile 141 of the group tasks 140 that Member_J had performed in the past. The team 3212 of Task_T record 321 is a subgroup of members to which Task_T had been assigned, in which Member_J is included. The team score 3213 of Task_T record 321 indicates a numerical value or a point in a preconfigured grading scale, which represents how well the team 3212 had performed with Task_T. The team score 3213 of Task_T record 321 may be evaluated based on group dynamics indicating how efficiently members of the subgroup communicated, collaborated, and/or engaged, as provided by member feedback. The team score 3213 may also be measured in terms of the period of time between assigning Task_T and completion of Task_T.

The exemplary instance of Member_J profile 302 includes Member_J calendar 330. Member_J calendar 330 specifies during which time slots Member_J would be occupied by other activities and during which other time slots Member_J would be available for the group task 140. Member_J calendar 330 may take inputs from event calendars to which Member_J subscribes, regular schedules and/or routines of Member_J, or may be generated by various statistical modeling based on the past schedules and the inputs affecting availability of Member_J, as presented in this specification. Member_J calendar 330 may include a work schedule 331 of Member_J, recurring events per subscription/routine 332, and simulated unscheduled events 333.

Certain embodiments of the present invention may offer various technical computing advantages, including automated assignment of a collaborative task to a team of qualified members and notification for the team to perform the assigned task. Certain embodiments of the present invention analyzes requirements of the collaborative task in terms of required skill sets of members to perform the collaborative task, and a completion time for the collaborative task. Certain embodiments of the present invention also analyzes respective skill sets availability of individual members according to member profiles by use of a selected statistical modeling. Based on member task histories of respective member profiles, certain embodiments of the present invention may utilizes past teams and respective team scores in determining group dynamics of individual members, such that the collaborative task would be assigned to a team with optimal group dynamics, provided that the required skills are equal. Certain embodiments of the present invention monitor real-time changes in respective member calendars and provide further notice to team members while the collaborative task is ongoing such that scheduling of the collaborative task may be adjusted accordingly. Certain embodiments of the present invention may be implemented by use of a cloud platform/data center in various types including a Software-as-a-Service (SaaS), Platform-as-a-Service (PaaS), Database-as-a-Service (DBaaS), and combinations thereof based on types of subscribed scheduling service. Accordingly, the scheduling service for collaboration in a group may be provided for any type of entities in need from any location in the world.

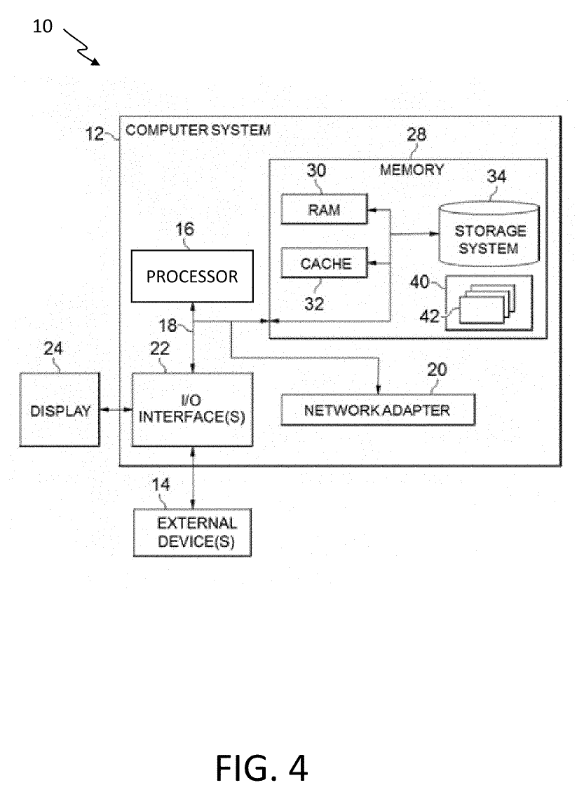

FIGS. 4-6 depict various aspects of computing, including a cloud computing system, in accordance with one or more aspects set forth herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 4, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the scheduling engine 120 and the group collaboration system 110 of FIG. 1, respectively. Program processes 42, as in scheduling engine 120 and the group collaboration system 110, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processors, external disk drive arrays, RAID systems, tape drives, and data archival storage systems, etc.

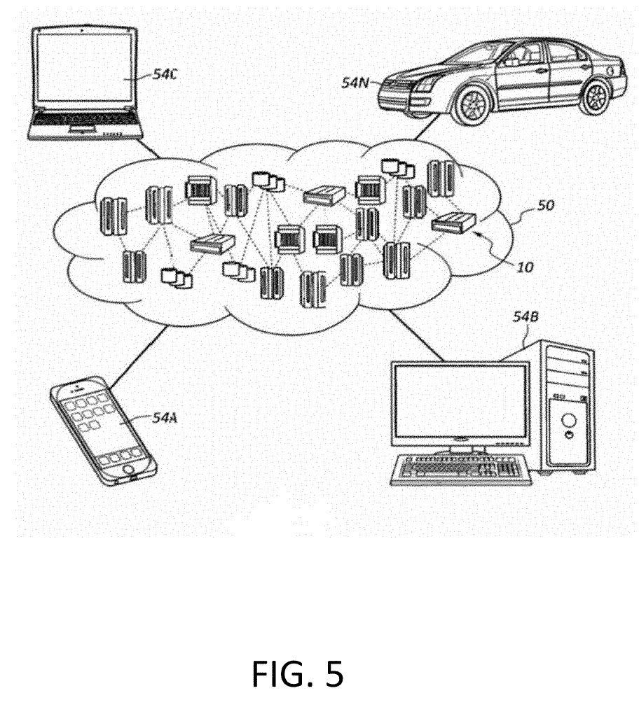

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

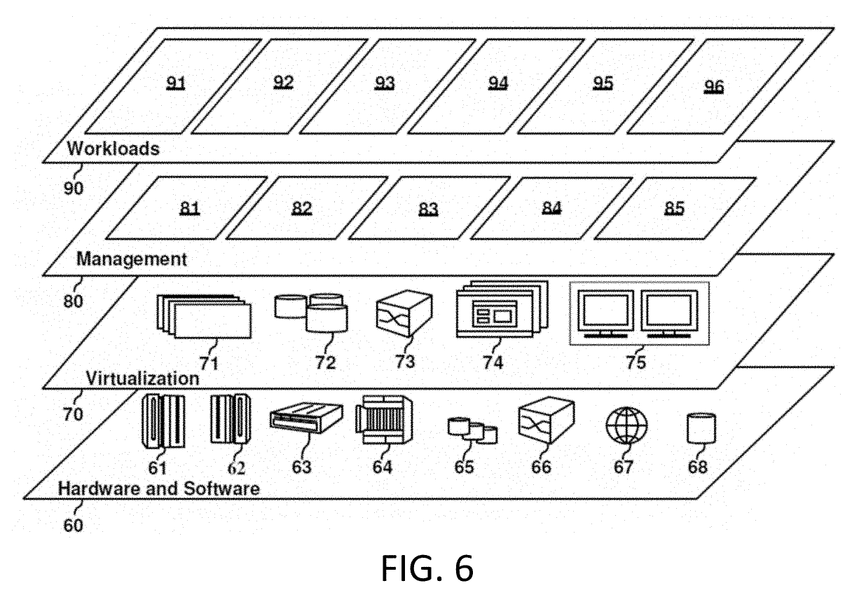

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the collaborative scheduling services as provided by the scheduling engine 96, as described herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for cognitively scheduling a group task for a plurality of individual members, comprising:
obtaining, by one or more processor, the group task, wherein the group task is to be performed by two or more individual members, wherein the group task is specified by a task profile including a type of required skill to perform the group task;
modeling, by the one or more processor, respective availabilities of the individual members for the group task, based on respectively estimated time of completion, and based on respective member calendar;
building, by the one or more processor, a group free time model, by use of availability models for the individual members from the modeling;
selecting, by the one or more processor, a subgroup of the individual members to assign the group task, based on the group free time model, member preference, and a team score, if applicable; and
assigning, by the one or more process, the group task to the subgroup by notifying all members of the subgroup that the subgroup are to perform the group task such that the members selected for the subgroup would gather and/or coordinate performance of the group task.

2. The computer implemented method of claim 1, further comprising:
alerting, subsequent to the assigning, respective members of the subgroup of any changes in availability of the members of the subgroup, by monitoring respective member calendars for any changes in real-time, such that the group task may be rescheduled to another time and/or another individual member may join the subgroup, in order to complete the group task as specified in the task profile.

3. The computer implemented method of claim 1, wherein the task profile of the group task further comprises a required skill level of the type, a number of members and/or hours estimated to complete the group task, an expected completion date, and combinations thereof.

4. The computer implemented method of claim 1, further comprising:
analyzing, prior to the modeling, a member task history of a member profile corresponding to an individual member, for a skill of the individual member, wherein the member task history includes one or more task record; and
associating the skill to the individual member in the member profile, wherein the skill comprises a skill type, a skill level, and a skill confidence score, the skill type indicating a kind of the skill of the individual member, the skill level indicating a proficiency level of the individual member with the skill, and the skill confidence score indicating a probability on certainty of the skill type and the skill level.

5. The computer implemented method of claim 3, wherein a time of completion for the group task by the individual member is estimated by use of the skill type and the skill level.

6. The computer implemented method of claim 4, the selecting comprising:
ascertaining that the individual member having the skill of the member profile that is equal to the type of required skill from the task profile;
determining that the individual member as a candidate for the subgroup as being qualified to perform the group task; and
selecting, the candidate as a member of the subgroup based on the group free time model, the member preference, and the team score, where applicable, in conjunction with respective member preferences and respective team scores of other candidates for the subgroup.

7. The computer implemented method of claim 1, wherein the respective availabilities of the individual members may be modeled by use of a renewal-reward process queue model, data resulting from a discriminant function model analysis, or the data with member feedback, such that the modeling may produce more training data for optimal scheduling of the group task.

8. A computer program product comprising:
a computer readable storage medium readable by one or more processor and storing instructions for execution by the one or more processor for performing a method for cognitively scheduling a group task for a plurality of individual members, comprising:
obtaining the group task, wherein the group task is to be performed by two or more individual members, wherein the group task is specified by a task profile including a type of required skill to perform the group task;
modeling respective availabilities of the individual members for the group task, based on respectively estimated time of completion, and based on respective member calendar;
building a group free time model, by use of availability models for the individual members from the modeling;
selecting a subgroup of the individual members to assign the group task, based on the group free time model, member preference, and a team score, if applicable; and
assigning the group task to the subgroup by notifying all members of the subgroup that the subgroup are to perform the group task such that the members selected for the subgroup would gather and/or coordinate performance of the group task.

9. The computer program product of claim 8, further comprising:
alerting, subsequent to the assigning, respective members of the subgroup of any changes in availability of the members of the subgroup, by monitoring respective member calendars for any changes in real-time, such that the group task may be rescheduled to another time and/or another individual member may join the subgroup, in order to complete the group task as specified in the task profile.

10. The computer program product of claim 8, wherein the task profile of the group task further comprises a required skill level of the type, a number of members and/or hours estimated to complete the group task, an expected completion date, and combinations thereof.

11. The computer program product of claim 8, further comprising:
analyzing, prior to the modeling, a member task history of a member profile corresponding to an individual member, for a skill of the individual member, wherein the member task history includes one or more task record; and
associating the skill to the individual member in the member profile, wherein the skill comprises a skill type, a skill level, and a skill confidence score, the skill type indicating a kind of the skill of the individual member, the skill level indicating a proficiency level of the individual member with the skill, and the skill confidence score indicating a probability on certainty of the skill type and the skill level.

12. The computer program product of claim 11, wherein a time of completion for the group task by the individual member is estimated by use of the skill type and the skill level.

13. The computer program product of claim 12, the selecting comprising:
ascertaining that the individual member having the skill of the member profile that is equal to the type of required skill from the task profile;
determining that the individual member as a candidate for the subgroup as being qualified to perform the group task; and
selecting, the candidate as a member of the subgroup based on the group free time model, the member preference, and the team score, where applicable, in conjunction with respective member preferences and respective team scores of other candidates for the subgroup.

14. The computer program product of claim 8, wherein the respective availabilities of the individual members may be modeled by use of a renewal-reward process queue model, data resulting from a discriminant function model analysis, or the data with member feedback, such that the modeling may produce more training data for optimal scheduling of the group task.

15. A system comprising:
a memory;
one or more processor in communication with memory; and
program instructions executable by the one or more processor via the memory to perform a method for cognitively scheduling a group task for a plurality of individual members, comprising:
obtaining the group task, wherein the group task is to be performed by two or more individual members, wherein the group task is specified by a task profile including a type of required skill to perform the group task;
modeling respective availabilities of the individual members for the group task, based on respectively estimated time of completion, and based on respective member calendar;
building a group free time model, by use of availability models for the individual members from the modeling;
selecting a subgroup of the individual members to assign the group task, based on the group free time model, member preference, and a team score, if applicable; and
assigning the group task to the subgroup by notifying all members of the subgroup that the subgroup are to perform the group task such that the members selected for the subgroup would gather and/or coordinate performance of the group task.

16. The system of claim 15, further comprising:
alerting, subsequent to the assigning, respective members of the subgroup of any changes in availability of the members of the subgroup, by monitoring respective member calendars for any changes in real-time, such that the group task may be rescheduled to another time and/or another individual member may join the subgroup, in order to complete the group task as specified in the task profile.

17. The system of claim 15, wherein the task profile of the group task further comprises a required skill level of the type, a number of members and/or hours estimated to complete the group task, an expected completion date, and combinations thereof.

18. The system of claim 15, further comprising:
analyzing, prior to the modeling, a member task history of a member profile corresponding to an individual member, for a skill of the individual member, wherein the member task history includes one or more task record; and
associating the skill to the individual member in the member profile, wherein the skill comprises a skill type, a skill level, and a skill confidence score, the skill type indicating a kind of the skill of the individual member, the skill level indicating a proficiency level of the individual member with the skill, and the skill confidence score indicating a probability on certainty of the skill type and the skill level.

19. The system of claim 18, wherein a time of completion for the group task by the individual member is estimated by use of the skill type and the skill level.

20. The system of claim 19, the selecting comprising:
ascertaining that the individual member having the skill of the member profile that is equal to the type of required skill from the task profile;
determining that the individual member as a candidate for the subgroup as being qualified to perform the group task; and
selecting, the candidate as a member of the subgroup based on the group free time model, the member preference, and the team score, where applicable, in conjunction with respective member preferences and respective team scores of other candidates for the subgroup.
